(19) United States
(12) Patent Application Publication
(10) Pub. No.: US 2007/0061272 A1
(43) Pub. Date: Mar. 15, 2007

(54) Access administration system and method for a currency compartment

(75) Inventors: David Delgrosso, Naperville, IL (US); Fraser Orr, Naperville, IL (US)

Correspondence Address: WALLENSTEIN & WAGNER, LTD., 311 SOUTH WACKER DRIVE, 53RD FLOOR, CHICAGO, IL, 60606, US

(73) Assignee: US Biometrics Corporation, Naperville, IL (US)

(21) Appl. No.: 11/512,444

(22) Filed: Aug. 30, 2006

Related U.S. Application Data
(62) Division of application No. 11/051,259, filed on Feb. 4, 2005.
(60) Provisional application No. 60/541,966, filed on Feb. 5, 2004.

(51) Int. Cl. G06Q 99/00

(52) U.S. Cl. 705/76

(57) ABSTRACT

An access administration system is provided for administering and controlling access to a currency compartment for currency. The system has a system computer for receiving user information comprising an identifier and unique biological identification information representing biological information of a particular user. The system stores the identifier and the unique biological identification information and associates the identifier with the unique biological identification information. The system has a biological identification information reader operably connected to the system computer and located proximate the compartment for reading the biological identification information of the user. The system further has a locking mechanism operably connected to the system computer for locking and unlocking the compartment, the system computer receiving and comparing the read biological identification information with the stored biological identification information for determining if a match exists. The system computer determines if the lock should be actuated to provide access to compartment for the user.

### CROSS-REFERENCE TO RELATED APPLICATIONS

This application is a Divisional Application of U.S. patent application Ser. No. 11/051,259, filed Feb. 4, 2005, which claims priority from U.S. Provisional Patent Application No. 60/541,966, filed Feb. 5, 2004.

### FEDERALLY SPONSORED RESEARCH OR DEVELOPMENT

None.

### TECHNICAL FIELD

The invention relates to access administration systems. In particular, the present invention relates to an access administration system for a currency compartment.

### BACKGROUND OF THE INVENTION

Bank teller drawer locks have been used for some time to keep unwanted persons from accessing bank teller drawers, to at least prevent theft. Keys have been provided to tellers in the past for locking and unlocking the currency drawers to give them access within a teller line and/or for drive up windows at banks. These currency drawers are typically stored in a vault having separate vault doors for each drawer or the same vault door for many currency drawers. A single or multiple keys are used to access the vault door(s) for the drawers. Keys are also used for obtaining access to operational compartments and spaces within ATMs within banks and at remote locations, to add currency and for other purposes.

Several problems are associated with these arrangements. First, tellers and other bank officials can lose keys. Second, keys can be stolen and doors and drawers can be opened by persons other than those persons who are intended to open such doors/drawers, causing theft, fraud, and other losses. Third, administration of tracking and assigning the keys to tellers and other bank officials can be difficult and cumbersome. In addition, each branch of each bank must have its own set of keys and its own system of administration of such keys in relation to tellers and bank officials which may work at the same branch or different branches.

The present invention is provided to solve the problems discussed above and other problems, and to provide advantages and aspects not provided by prior bank systems of this type. A full discussion of the features and advantages of the present invention is deferred to the following detailed description, which proceeds with reference to the accompanying drawings.

### SUMMARY OF THE INVENTION

The present invention is directed to an access administration system for administering and controlling access to a currency compartment for currency, such as a teller cash drawer located at a bank teller station and/or within a bank vault, or a cash compartment within an ATM. The system has a system computer for receiving user information comprising an identifier and unique biological identification information representing biological information of a particular user. The identifier can be at least a name, a number, a code, and/or a bar code. The biological identification information or biometric information can be a fingerprint, an eye pattern, and/or a DNA sequence. The system stores the identifier and the unique biological identification information. The system also associates the identifier with the unique biological identification information. The system has a biological identification information reader operably connected to the system computer and located proximate the compartment for reading the biological identification information of the user. The reader can be at least a fingerprint scanner, a retinal scanner, a facial structure scanner, and/or a DNA scanner. The system further has a locking mechanism operably connected to the system computer for locking and unlocking the compartment, the system computer receiving and comparing the read biological identification information with the stored biological identification information for determining if a match exists. The system computer determines if the lock should be actuated to provide access to the compartment for the user.

The system can have a separate universal administration application and a separate currency compartment access application. The separate universal administration application can be configured to interface with the separate currency compartment access application and with other function-specific applications, without the need to customize the interface for any particular function-specific application. The separate universal administration application and the separate currency compartment access application can reside within the same system computer of separate computers or servers at the same or different locations.

The system computer receives the user information at set up time (with the assistance of a manager), stores the identifier and the unique biological identification information, and associates the identifier with the unique biological identification information. The system computer further receives biological identification information of the user from a biological identification information reader located proximate the compartment. The system computer sends an unlock signal to unlock the compartment, in response to receiving and comparing the read biological identification information with the stored biological identification information and in response to determining that a match exists, for providing access to the compartment for the user. Depending on the application, the unlock signal can be sent to a bank vault, a remotely located ATM, through wired and/or wireless transmission, and/or to a bank branch located remotely from the source of the signal.

The system can be arranged to have a central access administration application and a separate currency compartment access application. The access administration application and the currency compartment access application transmit and receive requests and responses (commands, input data, output data, etc.) to such requests to and from one another through a plug-in interface. The system can further have function-specific applications different from the currency compartment access application, wherein the access administration application and the function-specific application transmit and receive requests and responses to such requests to and from one another through the plug-in interface as well. The central access administration application can operate with the function-specific applications different from the currency compartment access application without the need for operation or installation of the currency compartment access application. The access administration application and the currency compartment access application can reside on separate servers at different locations, communicating over a network. In one example for a teller application, the central access administration application is located at one bank location and operationally administers access functions for multiple bank branch locations.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an illustration of an overview of a system and method for a modular system for protecting resources using biometric credential information.

FIG. 2A is an illustration of a plug-in manager including a plug-in broker for providing plug-ins to client applications and receiving information from issued plug-ins.

FIG. 2B is an illustration of a structure of a plug-in arrangement for use with the present invention.

FIG. 3 is an illustration of a biometric login utility, to be used to gain access to an administrative system designed for use with the present invention.

FIG. 4 is an illustration of a non-biometric login utility, to be used to gain access to an administrative system designed for use with the present invention.

FIG. 5 is an illustration of a utility window to serve as a central management point for an administrative system for the present invention.

FIG. 6 is a detailed view of the navigation window of FIG. 5, for use in selecting a management focus for an administrative system of the present invention.

FIG. 7 is an illustration of a server overview window for displaying general information regarding a server embodying the principles of the present invention.

FIG. 8 is an illustration of a group overview window for modifying general information for user and user group information for a server embodying the principles of the present invention.

FIG. 9 is an illustration of a group management window for modifying specific user and user group information for a server embodying the principles of the present invention.

FIG. 10 is an illustration of a group addition window for creating a new user group for a server embodying the principles of the present invention.

FIG. 11 is an alternate view of a user group management window, to be used for modifying user group information on a server configured to embody the present invention.

FIG. 12 is an illustration of a new user window to be used to add a user to a server system embodying the concepts of the present invention.

FIG. 13 an illustration of a group overview window for displaying general information regarding a user group for a server embodying the present invention.

FIG. 14 is an illustration of a group management window for modifying the membership of a user group for an administrative system for the present invention.

FIG. 15 is an illustration of an exemplary use of the group overview window illustrated in FIG. 13.

FIG. 16 is an illustration of an exemplary use of the group management window illustrated in FIG. 14.

FIG. 17 is an illustration of an exemplary use of a user management window, for viewing and modifying information regarding a user for an administrative system embodying the principles of the present invention.

FIG. 18 is an illustration of a user credential window for specifying and storing biometrical credential information in accordance with the principles of the present invention.

FIG. 19 is an illustration of a user group window for viewing and modifying the user group memberships of a user in an administrative system for a server embodying the present invention.

FIG. 20 is an illustration of a user access window for viewing and modifying the resources which, and time periods during which, a user will have access according to the principles of the present invention.

FIG. 21 is an illustration of a user domain window for associating user information with domain information for an administrative system embodying the concepts of the present invention.

FIG. 22 is an illustration of a resource group window for viewing and modifying general information regarding a resource operated by a server embodying the principles of the present invention.

FIG. 23 is an illustration of a resource group overview window for viewing and modifying information regarding resource groups managed by a server embodying the elements of the present invention.

FIG. 24 an illustration of a new resource group window for adding a new resource group to a system embodying the present invention.

FIG. 25 is an alternate view of the resource group overview window illustrated in FIG. 23.

FIG. 26 is an illustration of a new resource window for adding a biometrically protected resource to an administrative server system embodying the principles of the present invention.

FIG. 27 is an illustration of a resource overview window for viewing general information regarding a resource protected by the biometric security system of the present invention.

FIG. 28 is an illustration of a resource management window for viewing a set of resources in an administrative server system embodying the principles of the present invention.

FIG. 29 is an illustration of a resource group access window for viewing and modifying aspects of biometric security control in accordance with the present invention.

FIG. 30 is an illustration of an exemplary use of the resource group window illustrated in FIG. 23.

FIG. 31 is an illustration of an exemplary use of the resource group overview window illustrated in FIG. 25.

FIG. 32 is an illustration of an exemplary use of the resource group access window illustrated in FIG. 29.

FIG. 33 is an illustration of a new resource access scenario window to be used in establishing a biometric protection plan in accordance with the present invention.

FIG. 34 is an illustration of an exemplary use of the resource overview window illustrated in FIG. 27.

FIG. 35 is an illustration of an exemplary use of the resource management window illustrated in FIG. 28.

FIG. 36 is an illustration of a time period overview window for viewing general information regarding a time period in an administrative server system embodying the concepts of the present invention.

FIG. 37 is an illustration of a time period management window for viewing general information regarding multiple time periods configured for use with the present invention.

FIG. 38 is an illustration of a new time period window for adding a time period to the administrative management system of the present invention.

FIG. 39 is an illustration of an exemplary use of the time period overview window of FIG. 36.

FIG. 40 is an illustration of an exemplary use of the time period management window illustrated in FIG. 37.

FIG. 41 is an illustration of an exemplary use of the new time period window illustrated in FIG. 38.

FIG. 42 is an illustration of a biometric login utility for requesting access to the administrative functions of a server configured in accordance with the present invention.

FIG. 43 is an illustration of a user management window for use in an administrative server system configured in accordance with the principles of the present invention.

FIG. 44 is an illustration of a new user window for adding information regarding a user to a system configured in accordance with the principles of the present invention.

FIG. 45 is an illustration of a schedule utility for scheduling time periods during which access to biometrically protected resources will be allowed.

FIG. 46 is an illustration of an audit trail utility window for viewing security transactions performed within a system embodying the present invention.

FIG. 47 is an illustration of a demon controller utility for providing information regarding the status of a system configured in accordance with the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

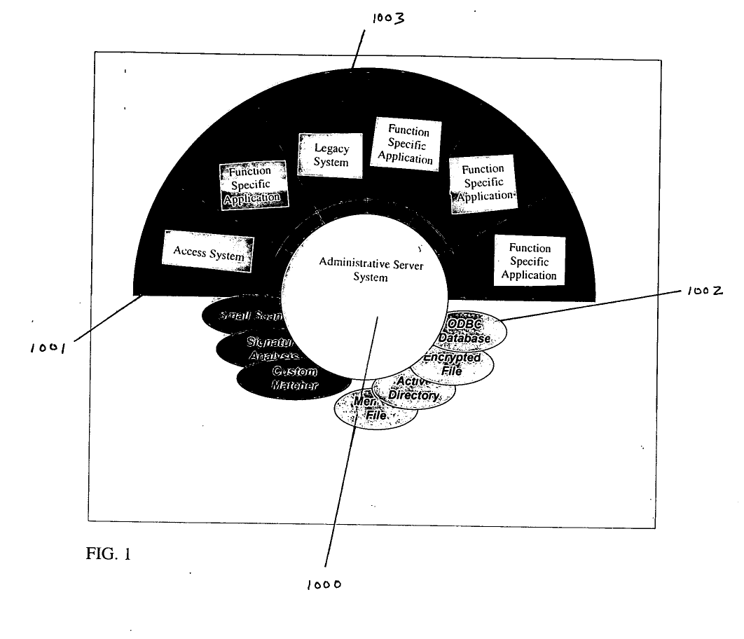

The present invention is directed to a system and method for the distributed modular biometrical protection of resources. Referring initially to FIG. 1, an administrative server system 1000 is provided to facilitate the distribution of software components embodying the present invention. The administrative server system 1000 communicates with various client applications, e.g., access system 1001, to provide biometrical identification and other services. In one embodiment, the administrative server system 1000 is computer software programmed to perform biometric signature analysis, such as by fingerprint matching. The administrative server system 1000 retrieves information and stores it in a database 1002, and compares that information to information received from the various client applications, e.g., access system 1001. Preferably, both the database 1002 and the communication between the administrative server system 1000 and the client applications are encrypted so as to provide a high level of security to the information transaction. While the present invention can be operated locally, i.e. within a single facility or a single network of computers, the system can also be operated via a wide area network (WAN) or via the Internet, so as to allow for global operation; the invention is thus scalable and operable in any desirable size network.

Database 1002 is built on top of a database engine; e.g., the Microsoft Data Engine, which is a data engine used with the Microsoft SQL Server 8.0. Database 1002 is preferably installed on a Windows server.

One purpose of the administrative server system 1000 is to await a request for communication from any of the various client applications. Thus, the administrative server system 1000 can operate in a “listening mode,” by scanning various computer network ports for the receipt of communication data from the client applications. It will also be appreciated that the administrative server system 1000 can comprise various server systems operating concurrently and even in different physical locations. Such redundant operation provides a high degree of reliability to the system, even in the event of a malfunction of one of the servers. That redundancy also allows for very fast communication with the administrative server system 1000, even in the event of high network traffic.

Another purpose of the administrative server system 1000 is to identify users based on some identification criteria. For that purpose, the database 1002 stores credential information in the form of biometric identity data, such as a fingerprint or retinal scan data. To provide a high level of security, database 1002 can also store non-biometric credential data, such as a login name and password. Those various credentials can be used in combination to provide increased security and reliability. In addition to being encrypted, as previously stated, the communication between the administrative server system 1000 and the client applications can also be authenticated based on a distributed key architecture or a token architecture, as will be understood by one of skill in the art. In combination, the multiple credentials, encryption, and authentication protocols of the present invention provide for a maximum degree of reliability and security.

Administrative server system 1000 communicates with a variety of different client applications. An example of such a client application is access system 1001, which communicates credential information from an access point to the administrative server system 1000. For example, access system 1001 can be installed at a controlled facility to control the operation of, for example, a door. In that example, access system 1001 receives biometric credential information from a user seeking access to open the door. A variety of different types of biometric input devices can be used with the present invention. A fingerprint reader, such as a SecuGen Hamster or SecuGen Optimouse device, can be used to scan the user's fingerprint. A numeric keypad can also be used, as can an RFID scanner, a retinal scan device, a credit card-style reader and a computer equipped with a keyboard for password entry. Those devices can be used alone or in combination with each other, depending on the level of security desired for the resource, e.g., the door. Access system 1000 receives the credential information from the user through one or more of those access devices, and communicates that credential information to the administrative server system 1000.

Administrative server system 1000 then compares the received credential information to credential information stored in the database. The credential information transmitted from access system 1001 to administrative server system 1000 can include the purported identity of the user, as is typical if the access device is a computer login or a card reader. If the purported user identity is included in the credential information, administrative server 1000 retrieves that user's credential information from database 1002 and compares that information with the credential information received from access system 1001. If the two sets of credential information match, then administrative server system 1000 transmits an access signal to access system 1001, which operates a solenoid to trigger access to the protected resource.

If the purported user identity is not included in the credential information transmitted from access system 1001 to administrative server system 1000, a search of database 1002 is performed. It will be understood that a variety of different search algorithms may be used to increase the speed of the search. For example, a list of frequent users can be maintained in database 1002, so that those users' entries are retrieved from database 1002 when seeking a match for the credential information. If a match for the credential information is found in database 1002, a signal is transmitted to access system 1001 for allowing access to the resource. If a match is not found in database 1002, a signal is transmitted to access system 1001 indicating that access to the resource should not be allowed.

The present invention may be used to protect a variety of different types of resources. Virtually any resource contained with a facility that is moveable from one position to another can be protected by the present invention. Examples include doors, drawers, gates, cubicles, turnstiles, switches and circuits, which are operably connected into the system from local physical locations or remote locations, connected through wired and/or wireless means.

Provided with the present invention is a method for adapting a non-biometric verification system for use with the biometric verification system of the present invention. Pre-existing credential information, such as user identification names and passwords, are retrieved from a pre-existing database by a legacy system 1003, which communicates that information to the administrative server system 1000 for storage in the database 1002. That pre-existing credential information is updated to include biometric credential information for access by the administrative server system 1000 as previously discussed.

One object of the present invention is to provide for the seamless integration of biometric protection technology across a variety of different platforms and computer software environments. Provided with the present system and method is an architecture for communicating biometric credential information and signals between a wide range of specific applications on the one hand and the centralized administrative server system 1000 on the other. A preferred embodiment of that architecture is the plug-in architecture, which generally will be understood by one of skill in the art. A plug-in is a software element or interface that enables communication between software applications of two different types, across different data formats, file formats and/or operating systems. The interface of a plug-in is universally standard, and thus a plug-in may be used to communicate data from one software application to another without the necessity of familiarity between those two applications.

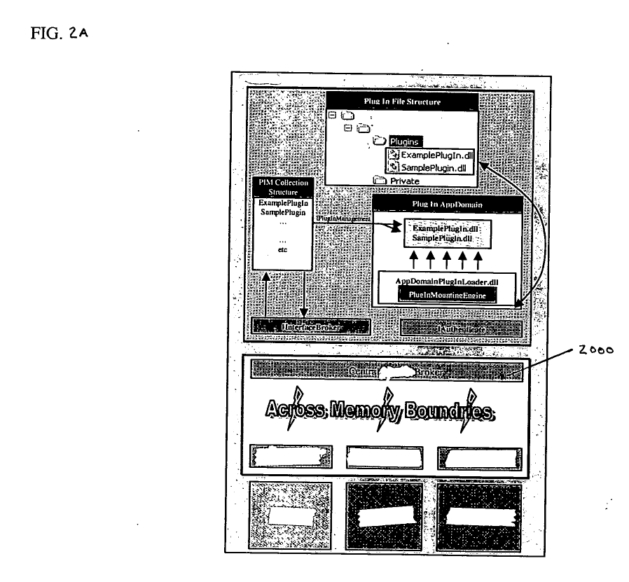

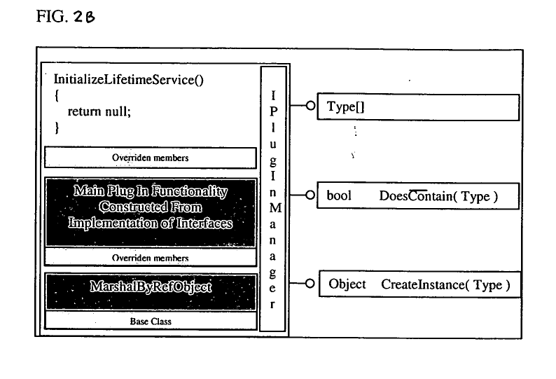

In the present invention, the administrative server system 1000 is provided with a plug-in manager, which effects the communication between the administrative server system 1000 and plug-ins residing in the various client applications. Referring to FIG. 2A, there is provided a plug-in broker 2000 that provides plug-ins to the various client applications, and receives information from those plug-ins. In one embodiment, plug-ins are distributed to client developers for use in developing software to communicate biometric credential information to the administrative server system 1000. The structure of a plug-in arrangement for use with the present invention is illustrated in FIG. 2B.

In another embodiment, a plug-in serves as a way to interchange biometric credential information between the administrative server system 1000 and a software application that was not initially designed for use with the present invention. Data output from the pre-existing software application is received by a plug-in designed for use with the current system, which in turn communicates that data to the legacy system 1003. Legacy system 1003 then communicates the credential information to the administrative server system 1000, which interfaces with the database 1002 to determine a match for the credential information as previously described. In that way, the present invention extends biometric credential protection to software applications that were not originally designed to work with the system of the present invention.

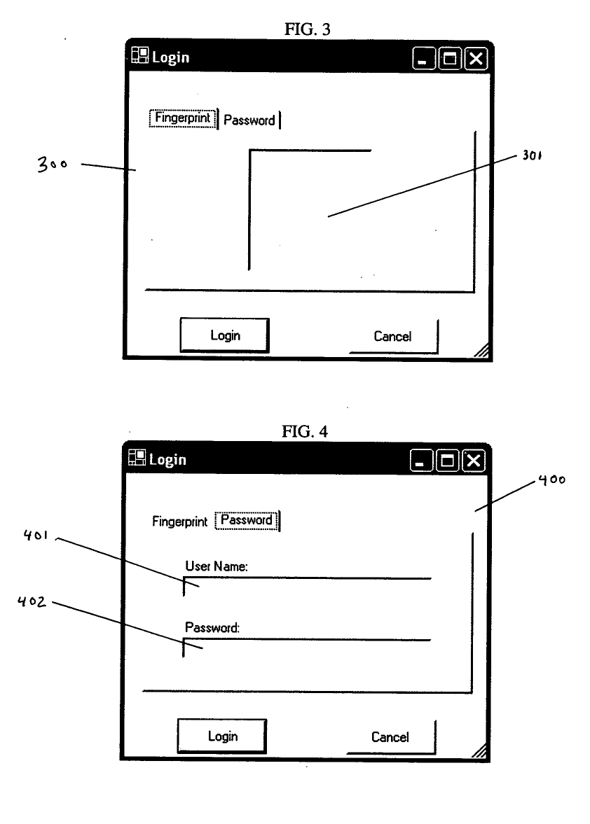

Referring to FIG. 3, there is illustrated a biometric login utility 300 to be used in accordance with the system of the present invention. Using the login utility 300, a user can gain access to the system in either a user or administrator capacity. Preferably, the user login is accomplished via a biometric input function 301, which can be a fingerprint scan, retinal scan, DNA scan or other mechanism to biometrically and uniquely identify the user.

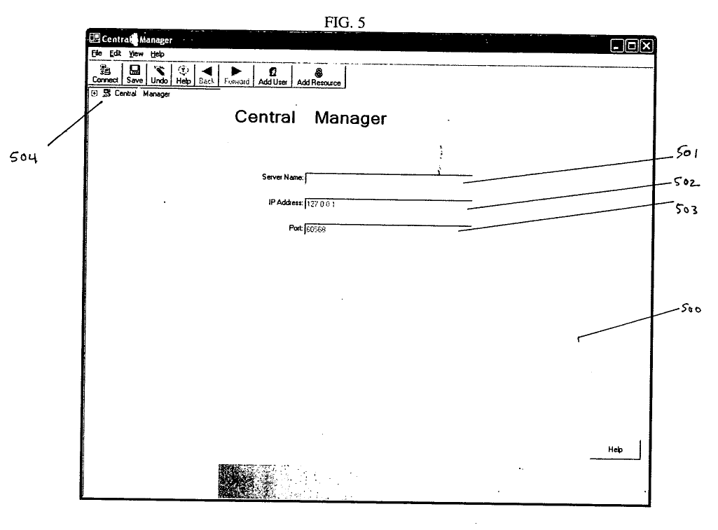

The user may also access the system via a non-biometric input function, such as that illustrated in FIG. 4. Such a mechanism is useful in the event of a malfunction in the biometric scanning equipment or in the event that a user login is required before a biometric identity has been established for that user. Additionally, enhanced security can be provided by requiring both a biometric security input such as that illustrated in FIG. 3 and a non-biometric security input such as that illustrated in FIG. 4.

Referring to FIG. 5, there is illustrated a utility window 500 for the management of a biometric security system in accordance with the present invention. The utility window 500 serves as a central management point for the user, from which the user can select additional and more particularized management functionalities. Additionally, the utility window 500 allows the user to view general information regarding the system. Specifically, the user can view and modify the server name 501 of the biometric security server, the IP address 502 of the server, and the network communications port 503 of the server. It is to be understood that multiple biometric security servers can be employed as part of a single system; in that event, those servers are each identified in the navigation window 504. Thus, using the navigation window 504, the user can select which server to view.

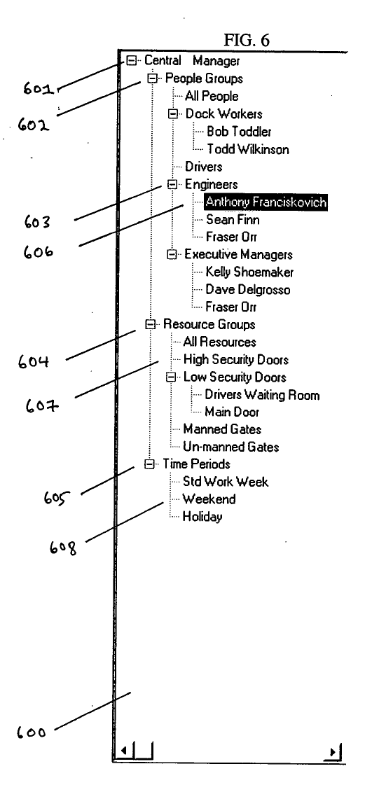

A more detailed view of the navigation window 504 is provided in FIG. 6, which shows an “expanded” view of a biometric security server 601. By using the navigation window 504, the user can select which element of the server 601 to view or modify. For instance, the user can view the various user groups 602 on the server. Each individual user 606 has unique security settings associated with that user; additionally, each user 606 can be part of a group 603, such as “Engineers.” Arranging individual users 606 into groups 603 improves the efficiency of administrating the system; a change made to a group 603 is propagated to each of its member users 606. Additionally, groups 603 can be made parts of larger groups 602; for example, the group “Engineers” can be a subgroup of “Location A.”

Using the navigation window 504, the user can also view the resources 604 that are to be controlled by the system. For example, a security door, a cash drawer, and an elevator can all be resources 604 monitored and controlled in accordance with the present invention. As illustrated in FIG. 6, resources 604 can be grouped using the navigation window 504. For example, while security doors A and B are each individual resources 604, those resources can be grouped into a more general group. That grouping allows a single modification to the group to be propagated to each of the members of the group. The user can also use the navigation window 504 to view time periods 605. As will be seen, the time periods 605 comprise individual schedule elements 608. Those schedule elements 608 can be further associated with users 606, groups 603, and resources 604. Multiple associations of that nature allow for maximum flexibility and specificity in the system. For example, the “main door” resource 604 can be associated with “engineer” user group 603, for the “weekday” time period 608. Via an intuitive “drag and drop” input mechanism, such as will be understood to one of skill in the art, the user can use the navigation window 504 to quickly and easily establish those associations.

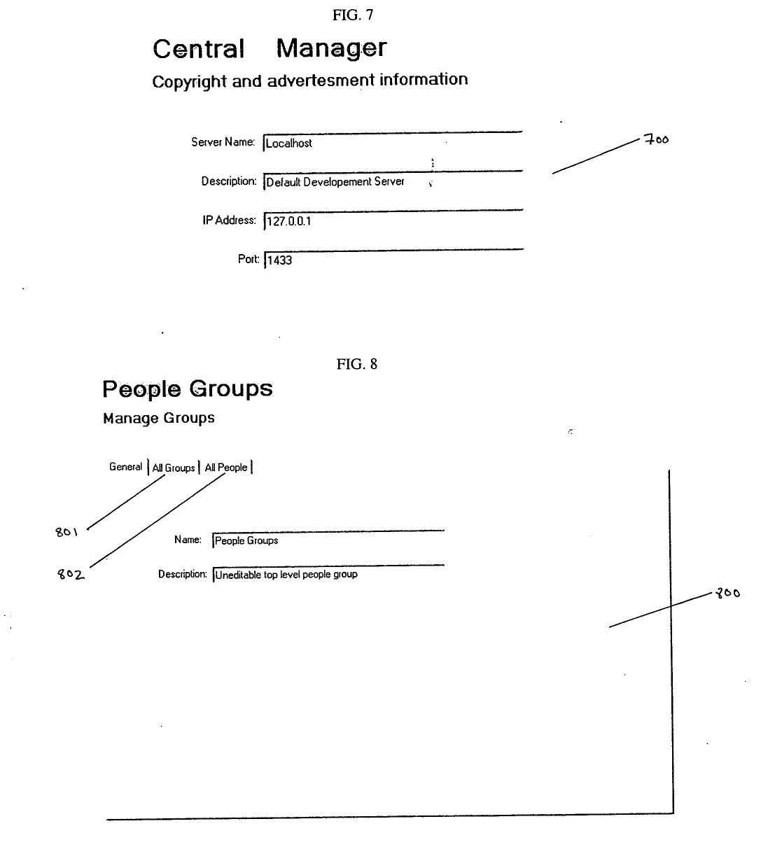

Referring to FIG. 7, there is illustrated a server overview window 700 for displaying general overview information regarding a server functioning in accordance with the present invention. The server overview window 700 provides general information corresponding to the server, such as the server name, description, IP address, and network port.

Referring to FIG. 8, there is illustrated a group overview window 800 for viewing and modifying the users 606 and user groups 603. From the group overview window 800, the user can select to navigate to either the group management window 900, by selecting the group management option 801, or to the user management window 1100, by selecting the user management option 802.

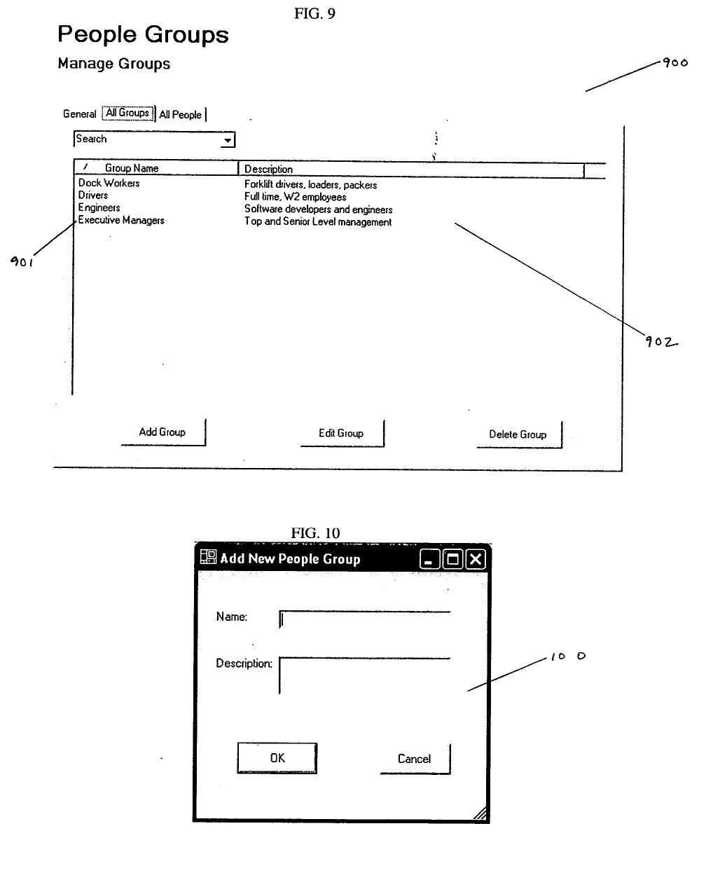

The group management window 900 is illustrated in further detail in FIG. 9. The group management window 900 allows the user to view all of the groups 603 that exist in the system and allows the user to add and delete those groups 603. Each group 603 is listed in the group management window 900 by its name 901 and by its optional description 902. As will be understood by one of skill in the art, the group description 902 is a way to provide an extra level of detail by which a group 603 can be easily identified by the user. As illustrated in FIG. 9, the group management window 900 allows the user to add a group 603 or to select an existing group 603 for edit or deletion.

Referring to FIG. 10, there is shown a group addition window 1010. The group addition window 1010 allows the user to add a group 603 to the system. The user provides group name 901 to the group and an optional group description 902. After that information is provided, the newly created user group 603 is added to the existing groups in the system.

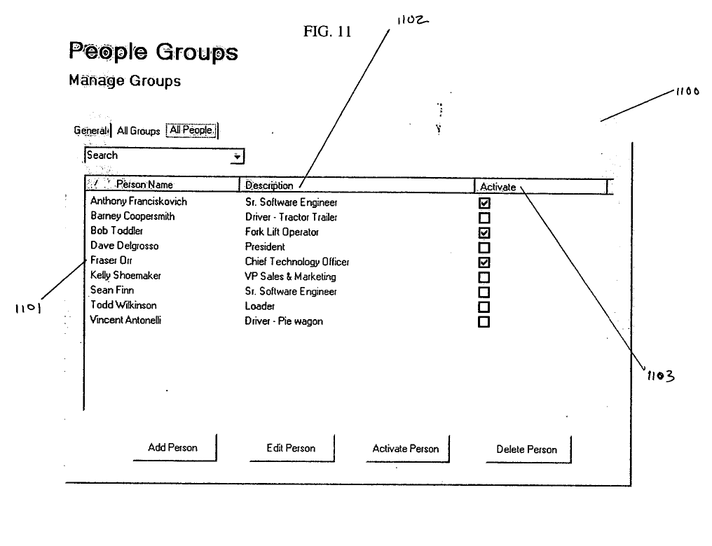

The user management window 100 is illustrated in further detail in FIG. 11. Similar to the group management window 900, the user management window 1100 allows the user to view and modify existing users 606. Each user 606 is listed in the user management window 1100 and is identified according to the user name 1101 and optional user description 1101. As illustrated in FIG. 11, the user management window 100 provides the user with the ability to add, edit and delete users 606 from the system; it also allows the user to change the active status 1103 of the users 606. A user 606 with an inactive status 1103 exists in the system, but is not enabled within the system, whereas a user 606 with an active status 1103 both exists within the system and is enabled to use the features of the system.

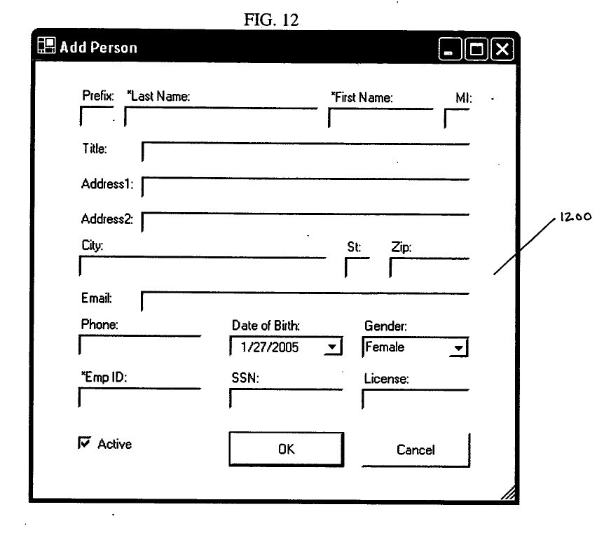

Referring to FIG. 12, there is illustrated a user addition window 1200 for use in adding a user 606 to the system. The user provides information to identify the new user 606, such as last name, first name, address, social security number, and employee identification number. It will be understood that any information that is of use to the system can be made available for entry in the user addition window 1200. It will also be understood that some information may be required, whereas other information may be optionally entered.

With respect to all of the windows illustrated in the drawings, it will be understood by one of skill in the art that such administrator windows need not be available to all users. In the present system, it is possible to make all of those windows available to all users, or to restrict them to administrator users of a certain type, or to make some of them available to all users and to restrict only some. Which administrator windows are available to which users can be determined on a window-by-window, or a user-by-user, basis.

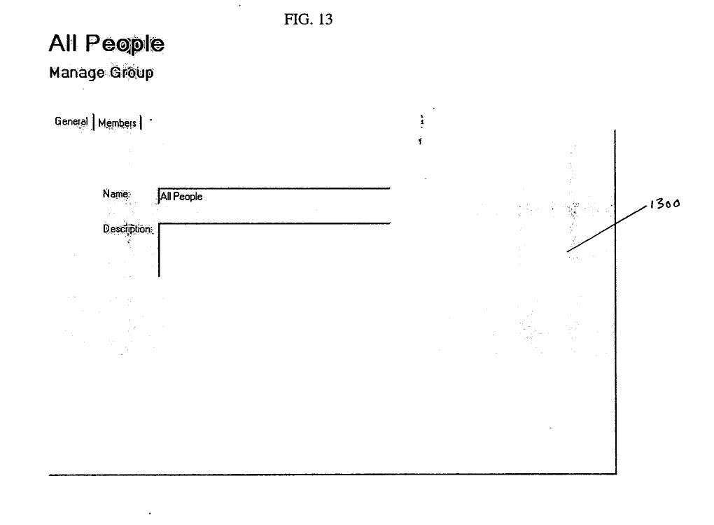

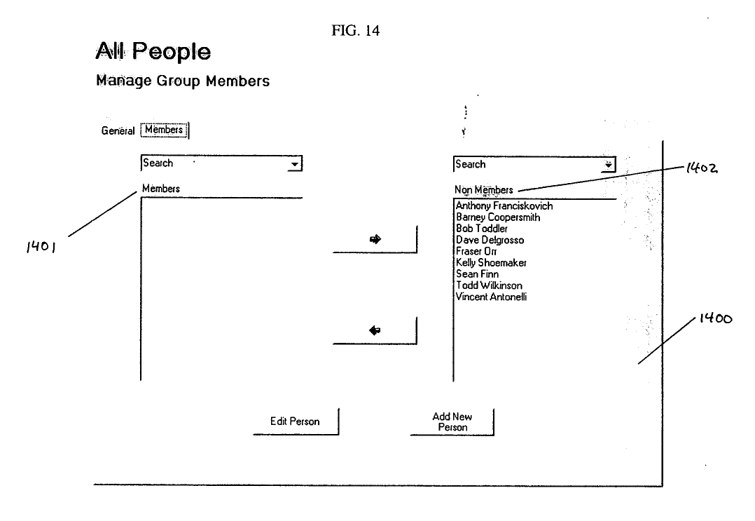

Referring to FIG. 13, there is illustrated a group overview window 1300. The group overview window 1300 allows the user to view and modify the name and description of a group. A more specific group management window 1400 is illustrated in FIG. 14. Using the group management window 1400, the user/administrator can manage a user group 603; specifically, the user/administrator uses the group management window 1400 to select which users 606 will be a member of the group 603. A user 606 who is not a member of the group 603 is listed in the group management window 1400 as being a non-member of the group 603; conversely, a user 606 who is a member of the group 603 is listed as being a member of the group 603. The group management window 1400 allows the user/administrator to switch users 606 from one list to another, thereby modifying the membership of the group 603. It will be understood that because groups 603 can be members of another group 603, groups 603 can also be listed as being a member of non-member of a group 603 in the group management window 1400.

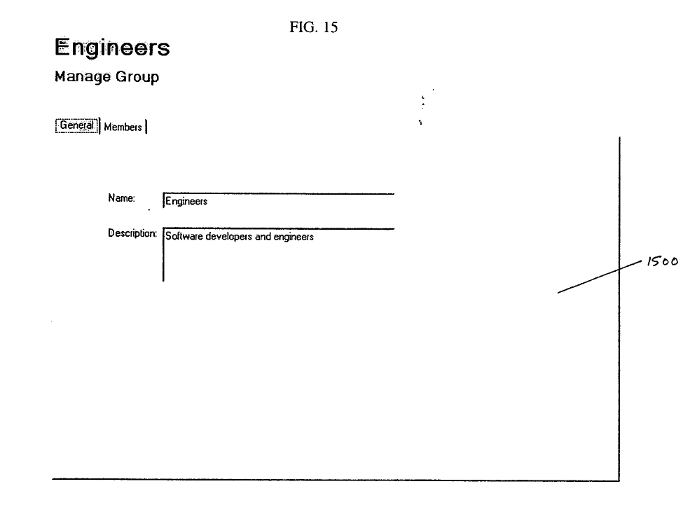

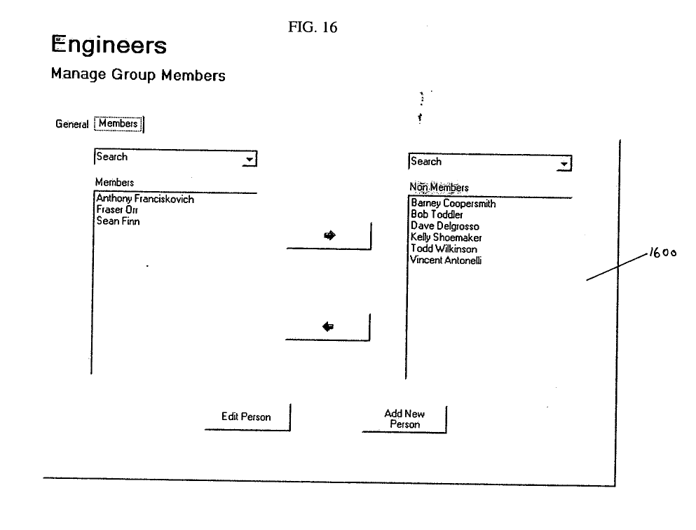

An exemplary use of the group overview window 1300 is illustrated in FIG. 15, wherein the user/administrator has selected to view the group “Engineers.” Using the group overview window 1300 as illustrated in FIG. 15, the user/administrator can select to change the name and/or the description of the “Engineers” group. A corresponding exemplary use of the group management window 1400 is illustrated in FIG. 16, wherein the user/administrator has selected to manage the group “Engineers.” Users 606 who are a member of the “Engineers” group are listed as being members, and users 606 who are not members of the group are listed as being non-members. As illustrated in FIG. 16, the user/administrator can use the group management window 1400 to modify the membership of the “Engineers” group.

It will be understood that the various windows illustrated in the drawings are not mutually exclusive to each other. In other words, a modification made in the group overview window 1300, for example, may also be reflected in the group management window 1400. As another example, a modification made to a specific user's data may also be reflected in the data for the groups to which that user is a member.

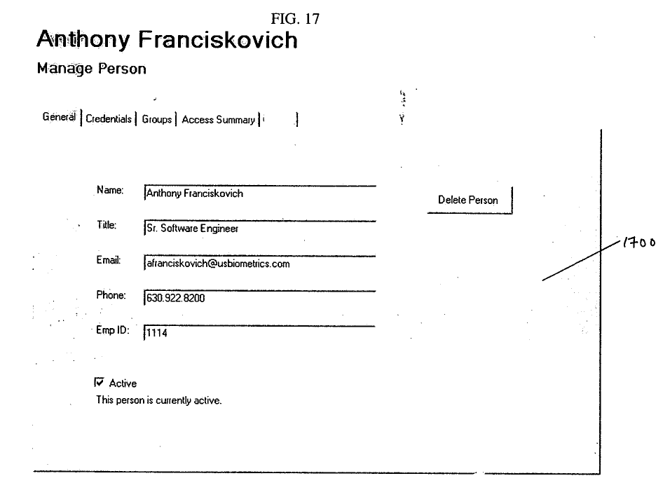

Referring to FIG. 17, there is illustrated a specific user management window 1700. The specific user management window 1700 differs from the user management window 1100 in that the user management window 1100 allows the user/administrator to view all of the users 606 of the system and to select which user 606 data to modify or alter. The specific user management window 1700, in comparison, displays information specific to an individual user 606. Via the specific user management window 1700, the user/administrator can view and modify the user's general information, such as the user's name, title, telephone number, and the like. It will be understood that any information helpful to the identification and description of the user can be included as part of the user's information in the user management window 1700.

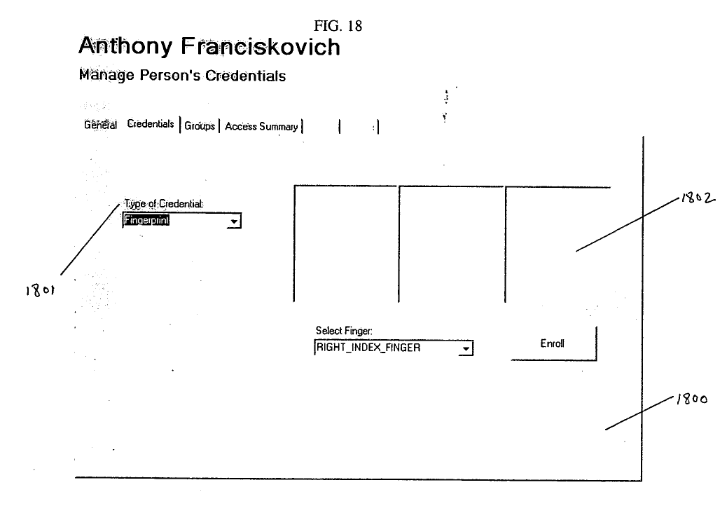

Referring to FIG. 18, there is illustrated a user credential window 1800 for use in the present invention. The user credential window 1800 pertains to a specific user 606, and allows the user/administrator to view and modify the user's 606 biometric credential information. It is through the user credential window 1800 that the system receives and stores biometric information pertaining to an individual user 606. Using the credential selector 1801, the user/administrator selects which type of biometric information is to be stored by the system, for example, fingerprint, retinal scan, and other types of uniquely identifying biometric information. Then, via the biometric input 1802, the user's biometric information is entered into the system. For example, if the user/administrator selects “fingerprint” using the credential selector 1801, then the user 606 can provide her fingerprint using the biometric input 1802. Once such information is stored in the system, it can be used to associate that particular user 606 to the available resources 604 of the system as described elsewhere herein.

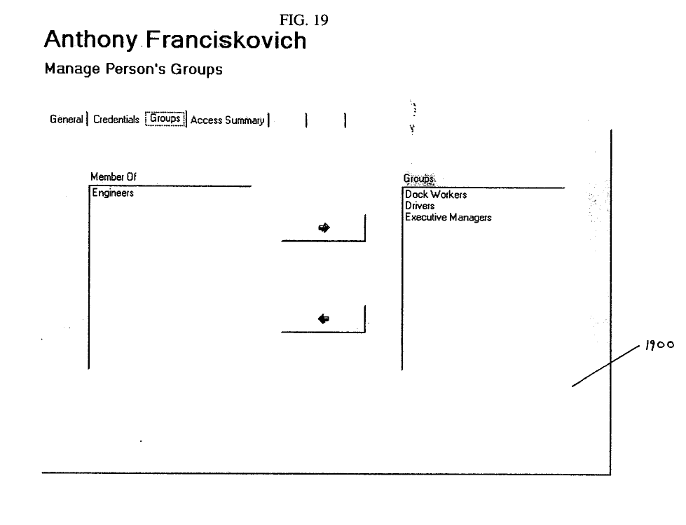

Referring to FIG. 19, there is illustrated a user group window 1900 for viewing and modifying the group 603 memberships of an individual user 606. The user group window 1900 differs from the group management window 1300 in that the user group window 1900 shows the group memberships for a specific user 606, whereas the group management window 1300 shows the group membership for a specific user group 603. The user group window 1900 displays the groups 603 of which the user 606 is a member and also displays the groups 603 of which the user 606 is not a member. By changing a particular group 603 from one list to another, the user/administrator can thereby easily modify the memberships of the specific user 606.

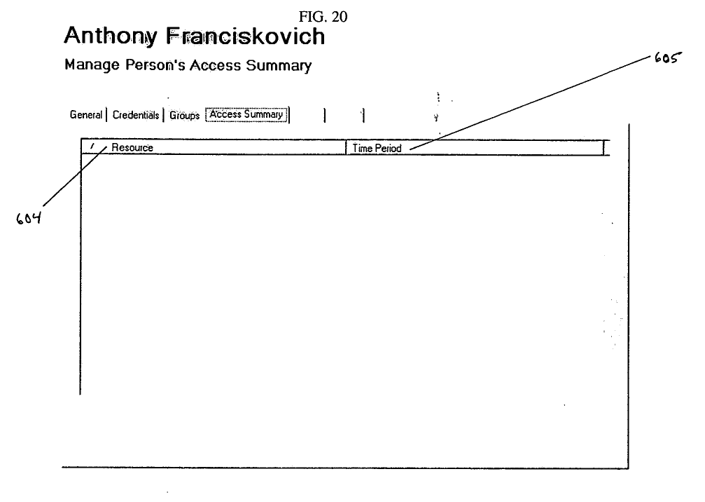

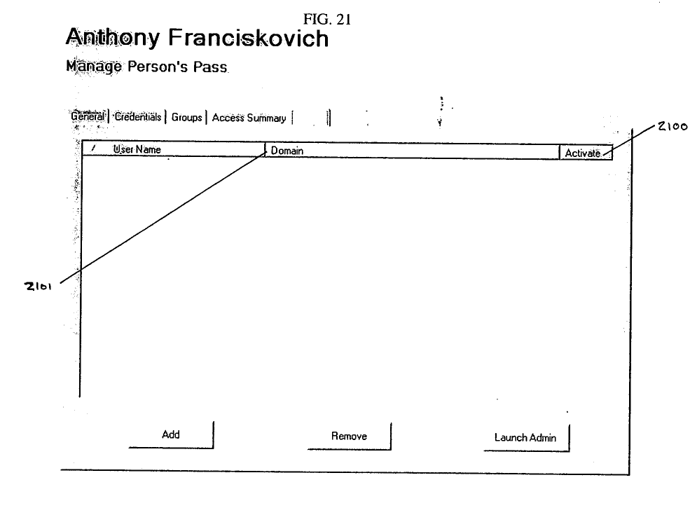

Illustrated in FIG. 20 is a user access window 2000 for viewing and modifying the resources 604 and time periods 605 to which a user 606 will have access. For example, the user/administrator can use the user access window 2000 to specify that a user's 606 biometric information will enable that user 606 to have access to a specific resource 604 during a specific time period 605. It will be understood that though such settings can be viewed and modified in the user access window 2000, that is not the only window in which those settings can be viewed and modified. In the navigation window 504, for example, those settings can also be viewed and modified.

Referring to FIG. 21, a user domain window 2001 is illustrated for associating a user 606 with domain 2101 information. A domain 2101 is a sphere of operation for a user; for example, a group of resources 604. Examples of domains 2101 include banks, hospitals, and factories; any grouping of resources 604 can function as a domain 2101. Via the user domain window 2001, the user/administrator can view and modify which domains 2101 a specific user 606 is associated with. Allowing domains 2101 to be viewed as groups of resources 604 rather than specific resources 604 allows for increased efficiency; instead of associating a user 606 with potentially hundreds or thousands of individual resources 604, those resources 604 can be grouped into a domain 2101, which can be associated with a specific user 606 a single time.

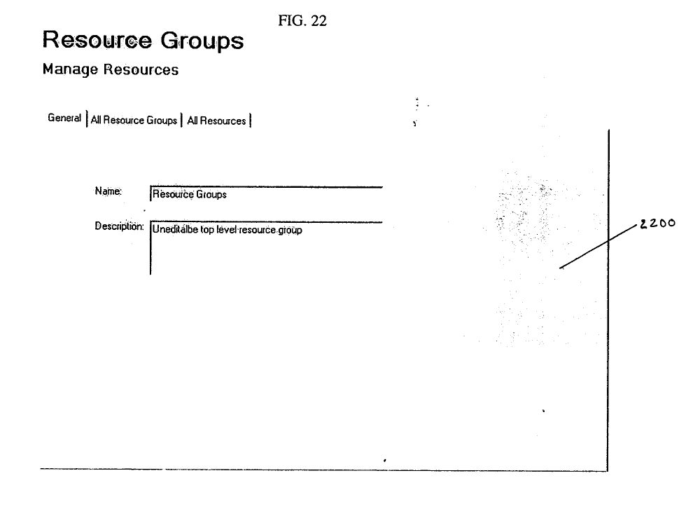

A resource group window 2200 is illustrated in FIG. 22, which allows the user/administrator to view and modify general information regarding a resource 604. Specifically, the user/administrator can use the resource group window 2200 to view the name and description of a specific resource group.

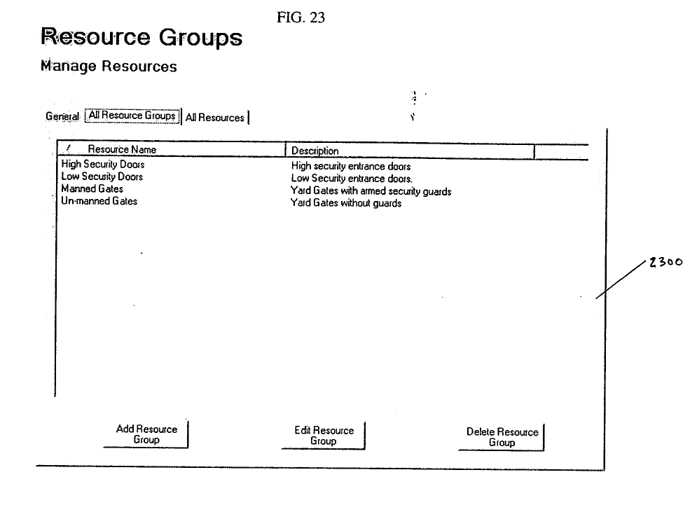

Referring to FIG. 23, a resource group overview window 2300 is illustrated, which allows the user/administrator to view all of the names and descriptions of each of the resource groups. It will be understood that resources 604 can be arranged in groups of resources, but such arrangement is not necessary. It will also be understood that individual resources 604 can also be listed in the resource group over window 2300 if such a listing is desired.

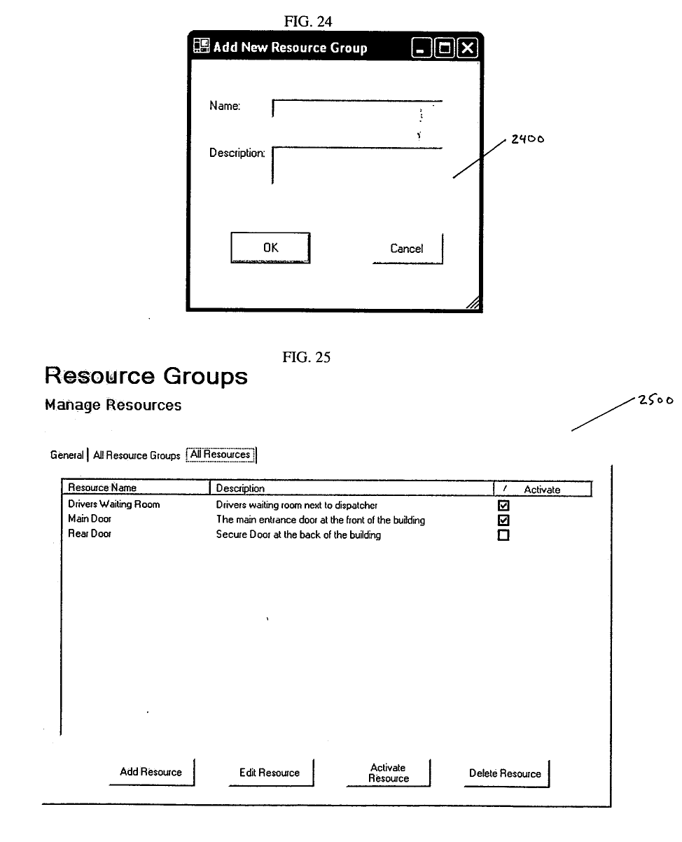

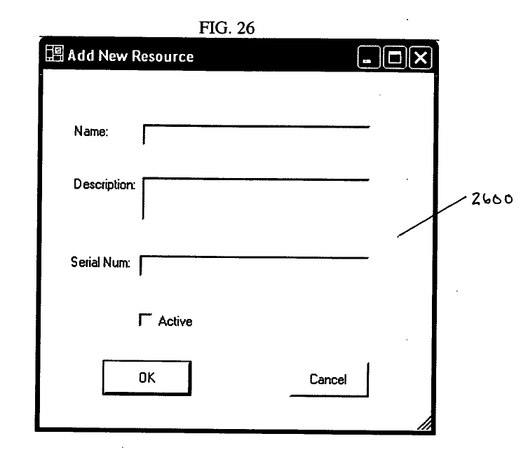

Illustrated in FIG. 24 is a new resource group window 2400 which allows the user/administrator to add a new resource group to the system by providing a name and optional description for the new resource group. Illustrated in FIG. 25 is an alternate view of the resource group overview window 2300. In the alternate resource group overview window 2500, the user/administrator can view and modify the “active” setting of any of the resource groups. To activate or inactivate a resource group, the user/administrator simply makes the appropriate selection in the resource group over window 2500. A new resource window 2600 is illustrated in FIG. 26, which allows the user/administrator to add a resource 604 to the system by providing a name and optional description of the resource 604.

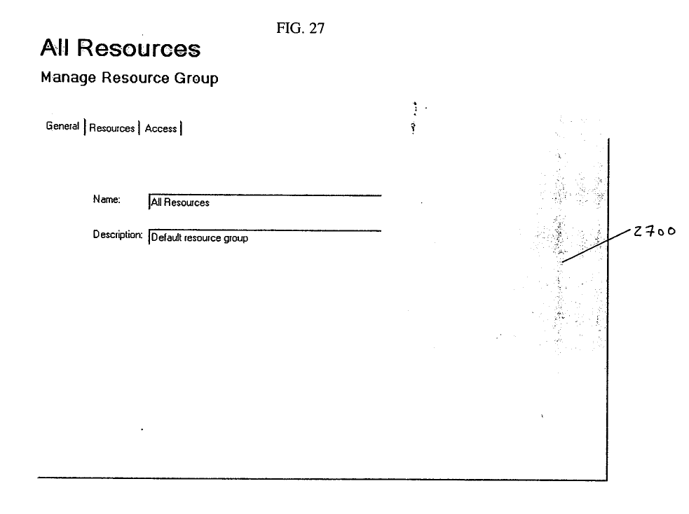

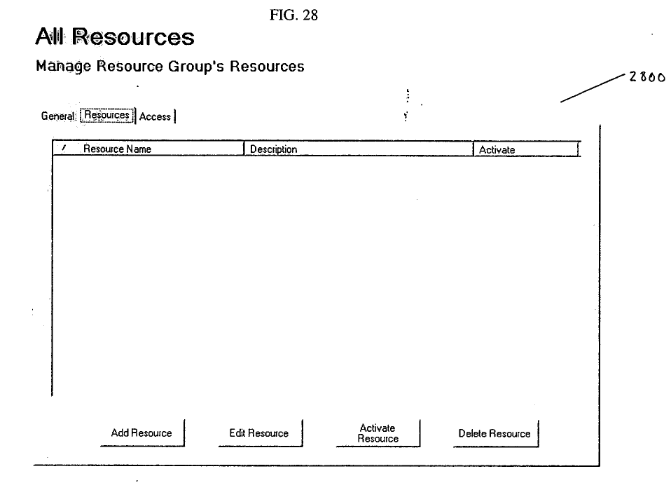

Referring to FIG. 27, there is illustrated a resource overview window 2700, which allows the user/administrator to view and modify the name and description of a specific resource 604. The resource overview window 2700 differs from the resource group overview window 2200 in that the resource overview window 2700 allows the viewing and modification of data regarding a specific resource 604, whereas the resource group overview window 2200 allows the viewing and modification of data regarding a group of resources 604. Illustrated in FIG. 28 is a resource management window 2800 which allows the user/administrator to view all of the resources 604 in the system and the descriptions of those resources 604. Via the resource management window 2800, the user/administrator can also activate or inactivate one or more of the specific resources 604.

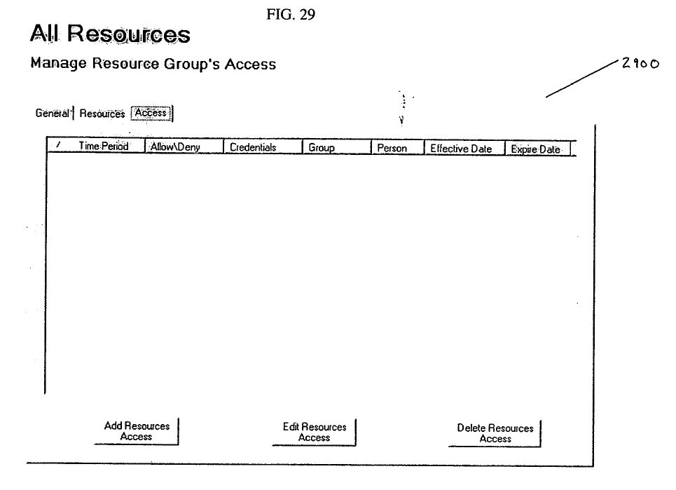

A resource group access window 2900 is illustrated in FIG. 29. Via the resource group access window 2900, the user/administrator can view and modify every aspect of the access to a specific group of resources 604. As illustrated in FIG. 29, the user/administrator can view the time period, i.e., the time of day, that access to a resource group is permitted. The user/administrator can specify which type of credentials, i.e., biometric information, will be required to access a resource group, which users 606 and/or user groups 603 will be permitted to access the resource group, and the dates on which such access will be permitted. It will be understood, of course, that any information of use to the user/administrator in determining the access to a group of resources 604 can be included in the resource group access window 2900.

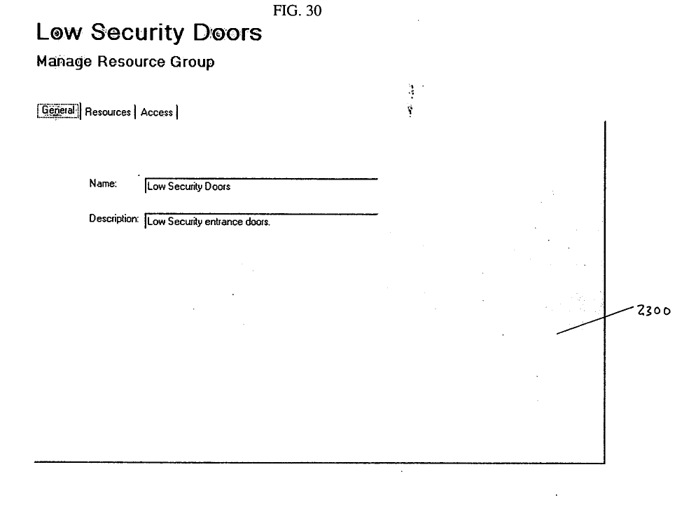

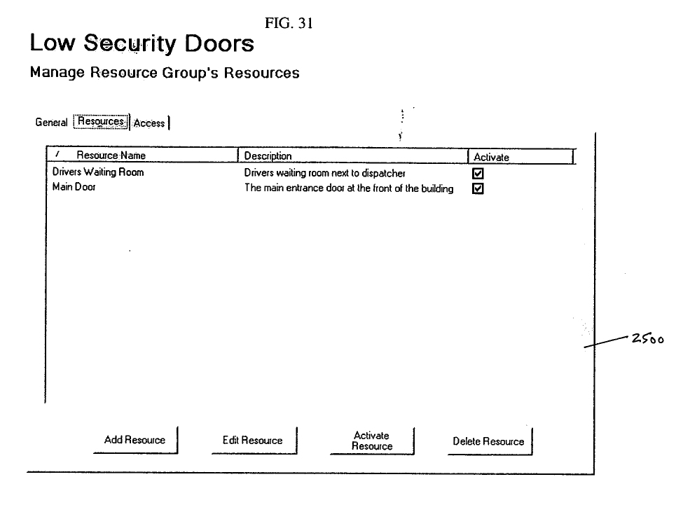

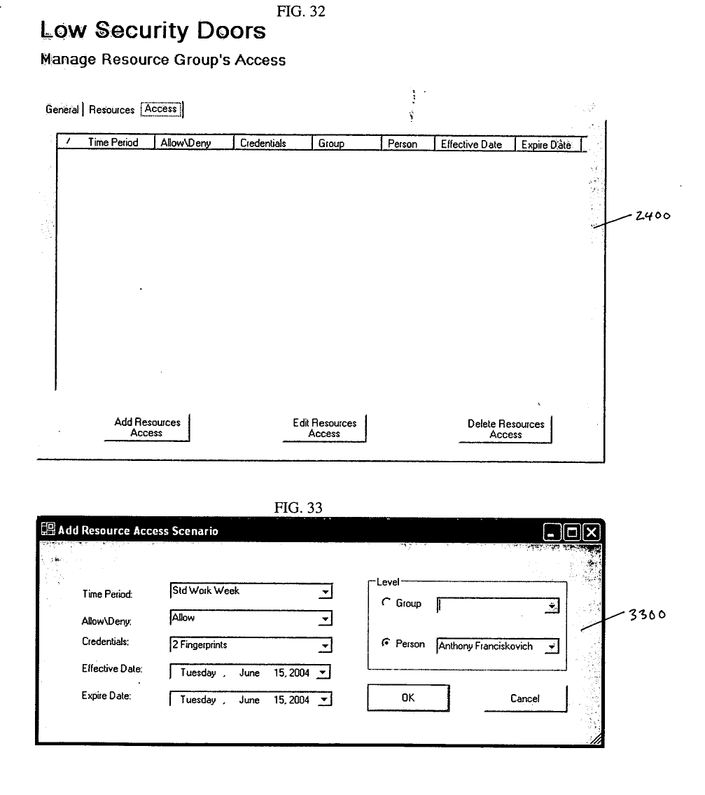

An exemplary resource group window 2300 is illustrated in FIG. 30. The resource group “Low Security Doors” and its corresponding description are illustrated in the overview window 2300. Using the resource group window 2300, the user/administrator can view and, if desired, modify that information. A corresponding exemplary resource group overview window 2500 is illustrated in FIG. 31. In the example depicted in FIG. 31, the “Low Security Doors” resources 604 are listed by name and description, and the user/administrator can use the resource group overview window 2500 to activate or inactivate any of the resources 604 of that resource group. A corresponding exemplary resource group access window 2900 is illustrated in FIG. 32. Using that window 2900, the user/administrator can specify the time period 605, users 606, user groups 603, required biometric information, and applicable dates for controlling the access to any of the resources 604 of the system.

Referring to FIG. 33, a new resource access scenario window 3300 is illustrated, which allows the user/administrator to specify the parameters for allowing access to a specific resource 604 or group of resources. It will be understood that such parameters can be submitted to the system via the new resource access scenario window 3300 as illustrated in FIG. 33, or via the resource group access window 2900 as illustrated in FIGS. 29 and 33. It will also be understood that any information useful to establishing or controlling access to a resource 604 can be included in the resource group access window 2900 and new access scenario window 3300.

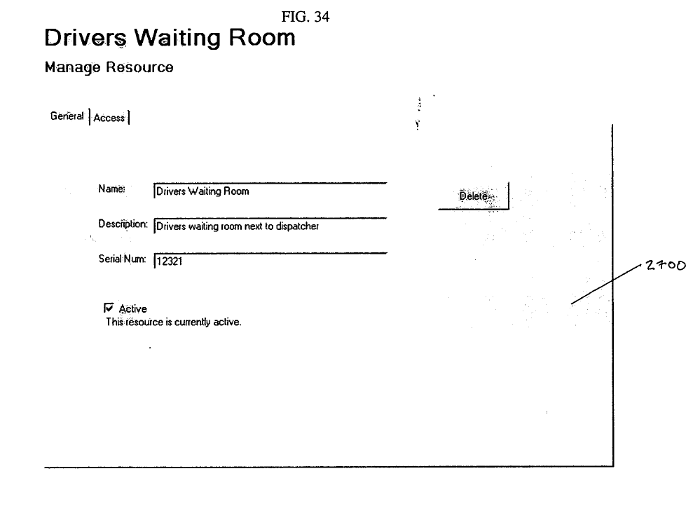

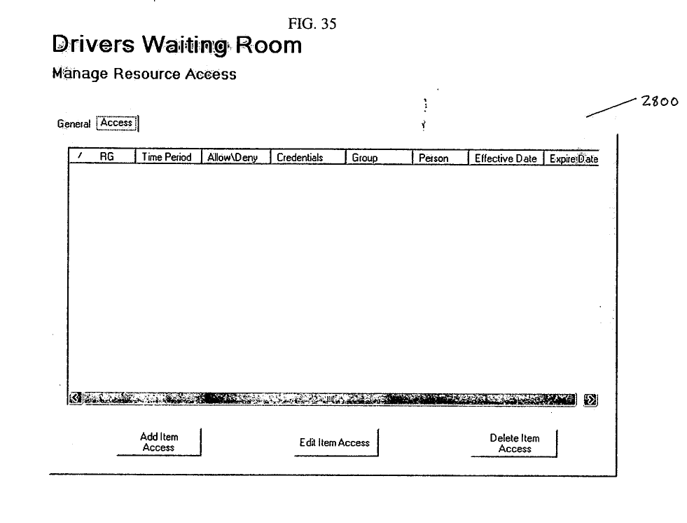

An exemplary resource overview window 2700 is illustrated in FIG. 34. As illustrated therein, the user/administrator can view and name and description of the resource 604. In this case, the resource 604 is the “Drivers Waiting Room.” As illustrated, additional information, such as the serial number of the resource 604, can be included in the resource overview window 2700. A corresponding exemplary resource management window 2800 is illustrated in FIG. 35, by which the user/administrator can modify any of the parameters for providing access to the resource 604.

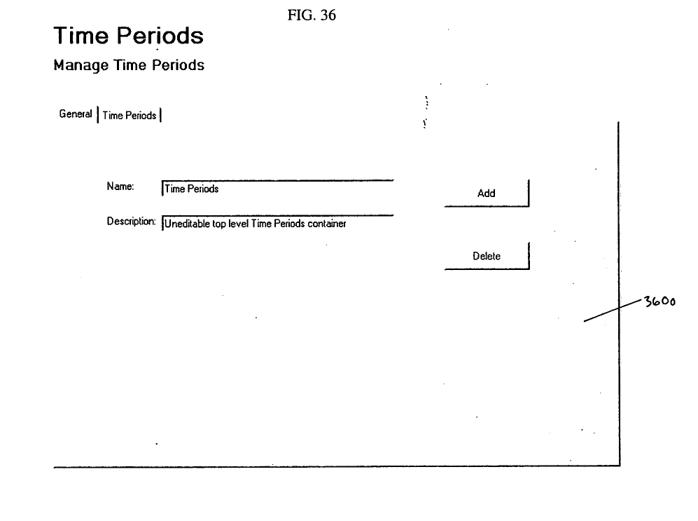

Referring to FIG. 36, there is illustrated a time period overview window 3600, which allows the user/administrator to view the name and description for any time period 605 of the system. It will be understood that like the resource overview window 2700, any information helpful to be included in the time period overview window 3600 may be so included.

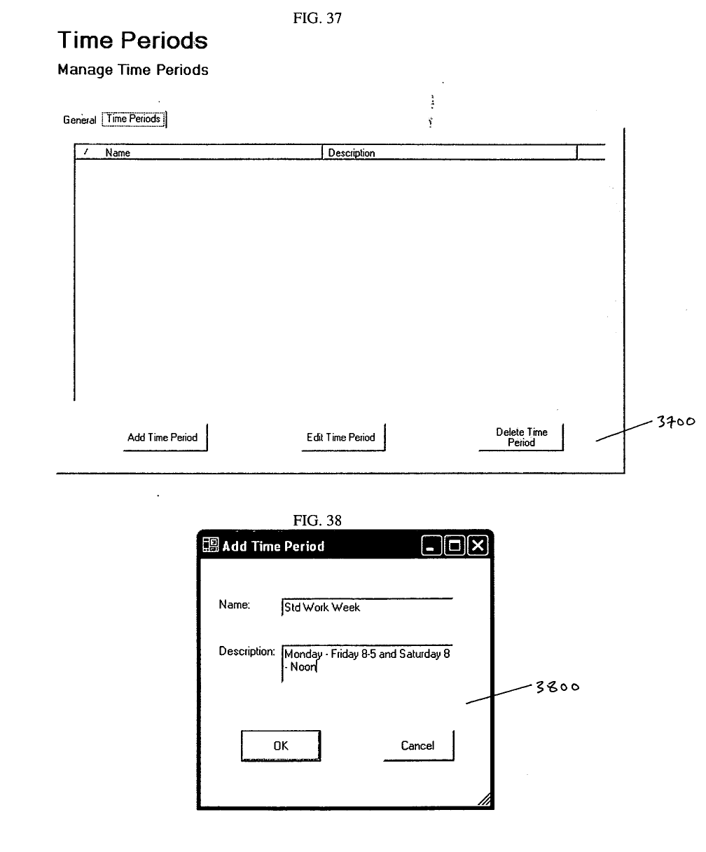

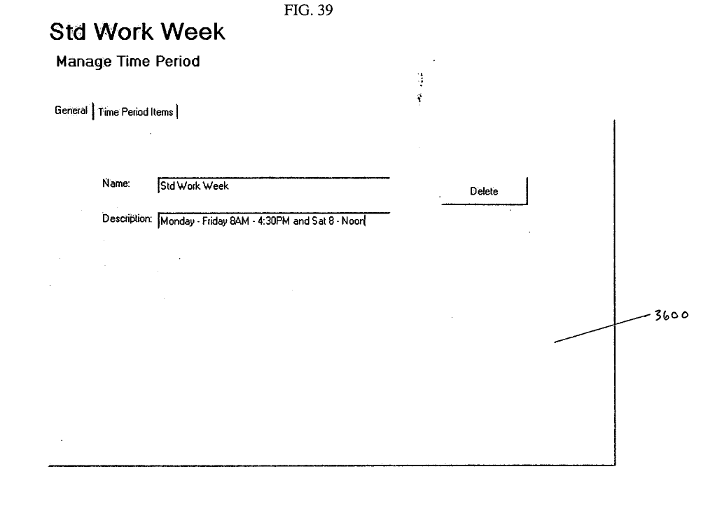

A time period management window 3700 is illustrated in FIG. 37. Using the time period management window 3700, the user/administrator can view the names and descriptions of all of the time periods 605 in the system. Via that window 3700, the user/administrator can remove an existing time period 605, add a new time period 605, or choose to edit an existing time period 605. According to a selection to add a new time period 605, a new time period window 3800 is illustrated in FIG. 38. The user/administrator can, via that window 3800, provide the name and description for a new time period 605, thereby adding that time period to the system.

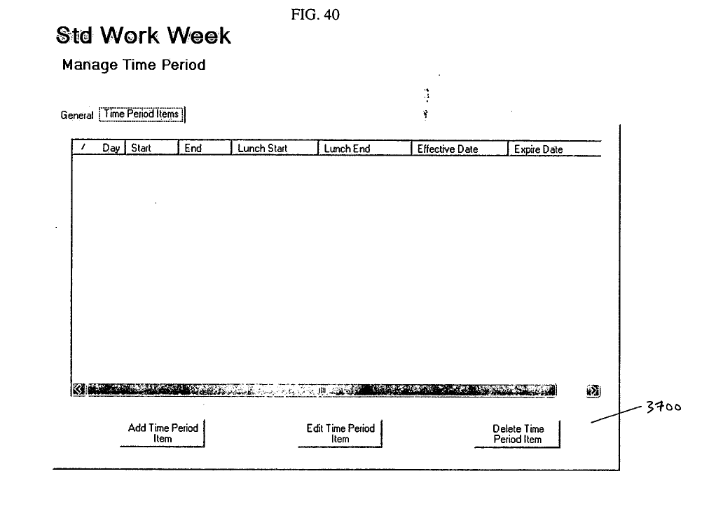

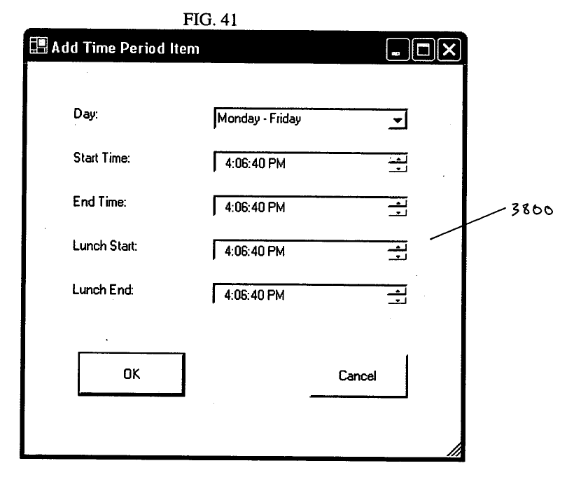

An exemplary time period overview window 3600 is illustrated in FIG. 39. In the example, the time period “Std Work Week” (standard work week) is being viewed by the user/administrator, who via the window 3600 can also modify the name and/or description of that time period 605. A corresponding exemplary time period management window 3700 is illustrated in FIG. 40 whereby the user/administrator can view the specific parameters of a time period 605, and if desired, modify those parameters. A corresponding exemplary new time period window 3800 is illustrated in FIG. 41, which allows the user/administrator to modify the parameters corresponding to the specific selected time period 605. It will be understood that modification of the time period 605 parameters can be made via either the new time period window 3800 or via the time period management window 3700.

One embodiment of the present invention is a system for managing the scheduled access of bank teller cash drawers with biometric credential matching technology, such as a fingerprint scan and match.

Cash drawers are generally removable trays that are stored in a locked cash vault when not in use. A teller withdraws a tray from the cash vault and places it in a locked drawer system next to the teller station. The present invention allows the control of cash drawers at both the teller station and the cash vault.

Current protection schemes for cash drawers involve standard key locks. Such systems wear out quickly and present security issues. If a teller should leave a bank without returning a key, for example, then all of the cash drawers at that bank must be refitted with new locks. Moreover, a stolen or misplaced key can lead to theft from the money stored in the cash drawers.

The present invention provides for biometrically controlled locks to control access to cash drawers. One object of the present invention is to allow managers to have direct control over the times at which a user can access a cash drawer. In a key environment, any user with a key can access a cash drawer at any time; in the biometric protection environment of the present invention, users can be prevented from accessing the cash drawers during specified times of the day, even if at other times of the day access is granted.

Current key lock systems do not indicate whether a cash drawer is open, closed, locked or unlocked. That limitation is highly disadvantageous, because an open or unlocked cash drawer is an egregious violation of most banking security policies. It is therefore an object of the present invention to control red and green lamps installed on the cash drawers to indicate whether the cash drawer is open, closed, locked or unlocked. The lamps have the additional benefit that they can be used to indicate whether power is adequately supplied to the cash drawer or not.

In the cash drawer embodiment, administrative server system 1000 enables four primary functions: enrolling and maintaining tellers, scheduling cash drawer access, viewing scheduled cash drawer access periods, and viewing all cash drawer activity.

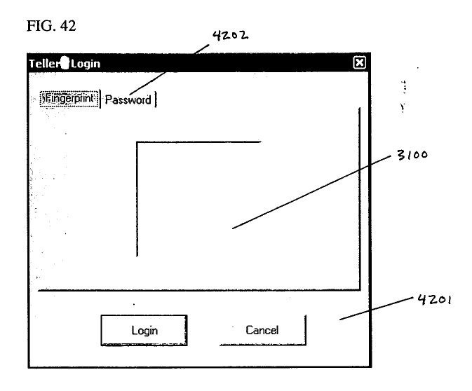

Both the cash drawers and the administration portal for the administrative server system 1000 require at least one credential information to be opened or initiated, respectively. Referring to FIG. 42, there is provided a biometric login utility 3000 by which the user seeking access to the administrative functions of the administrative server system 1000 can provide biometric credential information, such as a fingerprint by touching the fingerprint touch screen 4201. In the alternative or in combination to the biometric credential information, the user can be required to enter non-biometric credential information, such as a login ID and password, by selecting the “password” tab 4202 as indicated in FIG. 42.

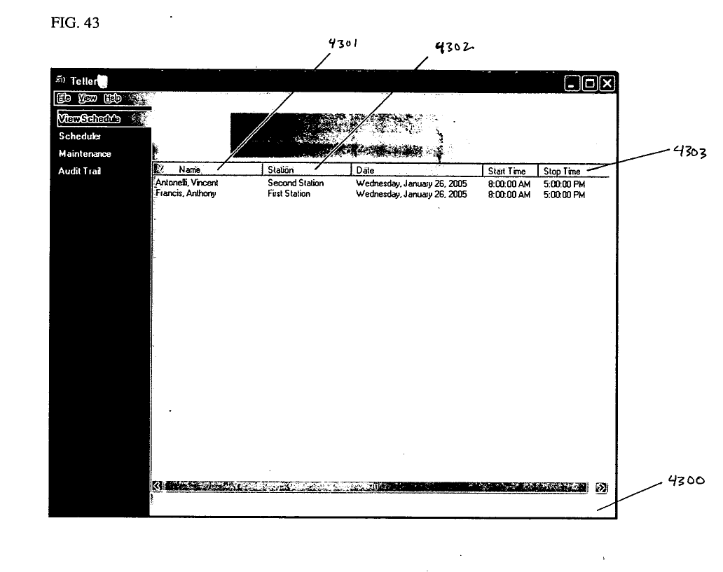

To enroll users in the present system and/or to update or maintain a user profile, a user management window 4300 is provided and illustrated in FIG. 43. The user management window 4300 displays the names 4301 of the users and the resources 4302 (e.g., “First Station”) those users are designated to access. The user management window 4300 also displays the times 4303 at which the system will permit access by those users to those resources 4302. If a user attempts to seek access to a resource 4302 for which he is not designated to have access, the system will reject the attempt. Likewise, if a user attempts to seek access to a resource 4302 during a time at which he is not designated to have access, the system will reject the attempt. The user management window 4300 is similar to the user group management window 1100 of the administrative server system 1000. As explained herein, the cash drawer embodiment is merely one embodiment for the concepts of the present invention; the user group management window 1100 is merely an abstract representation of the exemplary user management window 4300 of the cash drawer environment illustrated in FIG. 43.

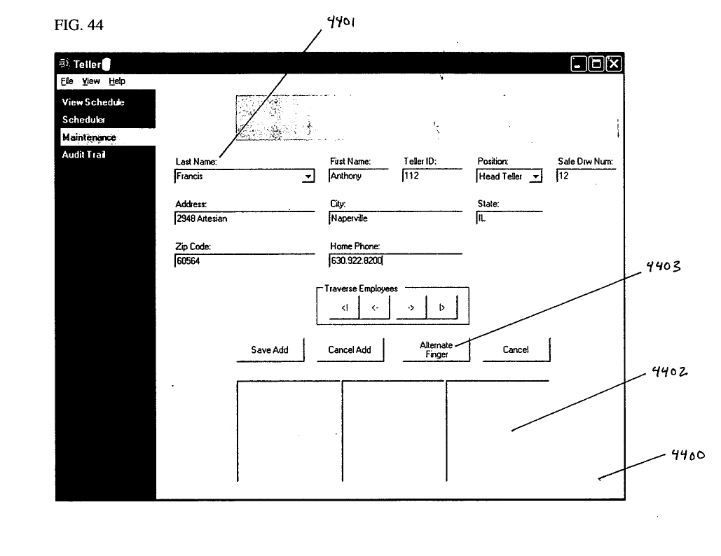

Referring to FIG. 44, the cash drawer protection system embodiment of the present invention is provided with a new user window 4400 for adding information regarding a new user of the system. As illustrated, general information 4401 regarding the user, such as name, address, telephone number, employee position and the like can be added to the database. As part of that enrollment process, biometric credential information 4402 can also be added to the database as part of the user profile. The new user utility 4400 further provides for different types of biometric credential information to be entered to the system. The user/administrator is provided with a credential selection utility 4403, which allows for the provision of a different or superlative set of biometric credential information. For example, and as illustrated, the user/administrator can select an “alternate finger” button, to allow for the recording of multiple fingerprints. That credential selection utility 4403 can also provide for the recording of an entirely different type of credential entry, such as a retinal scan, or any of the other types of biometric credentials discussed herein. The new user window 4400 is an exemplary use of the new user window 1200 illustrated in FIG. 12, with a biometric credential input function 301, 4402 added to the window 4400.

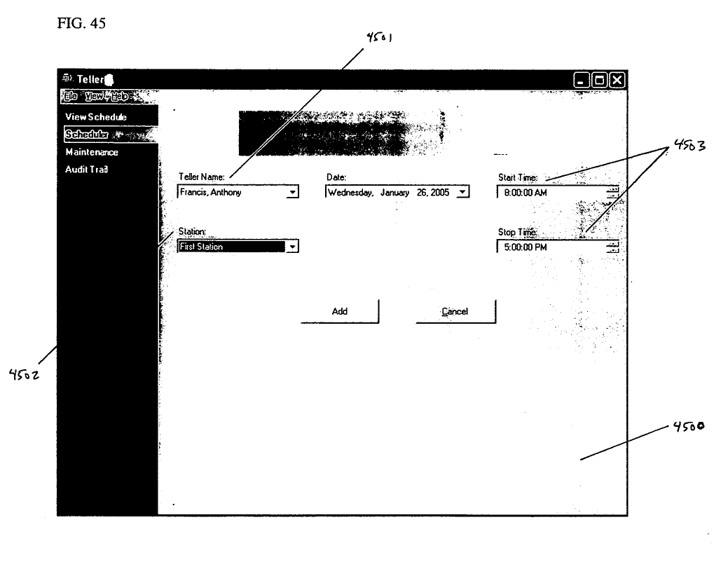

Referring to FIG. 45, a schedule utility 4500 is provided to allow the user/administrator to schedule the times at which a specific user will have access to a specific resource. As discussed herein, the present invention allows for maximum flexibility in determining not only which users and which types of biometric credential information will provide access to a resource, but also the times at which such access will be allowed. In the schedule utility 4500, the user/administrator uses a user select utility 4501 to choose the user for whom to schedule access, and then uses a resource select utility 4502 to select the resource for which access is to be granted. Lastly, the user/administrator uses a time period selection utility 4503 to select the time periods during which the selected user will have access to the selected resource. Schedule utility 4500 is an exemplary embodiment of the user access window 2000, illustrated in FIG. 20.

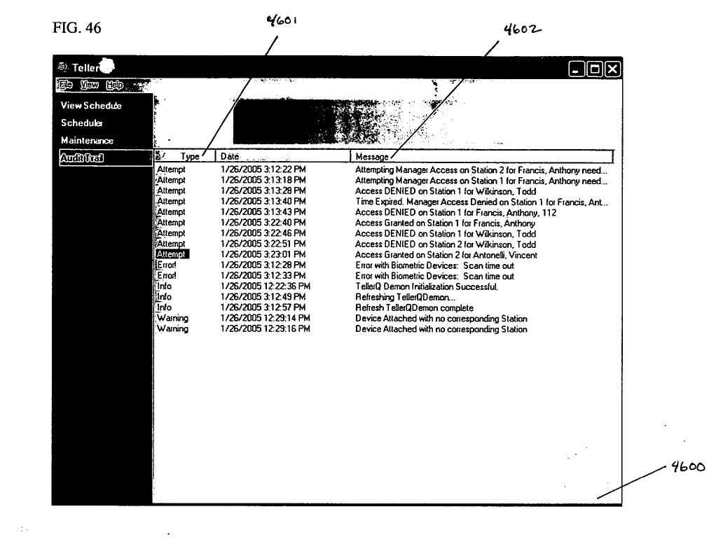

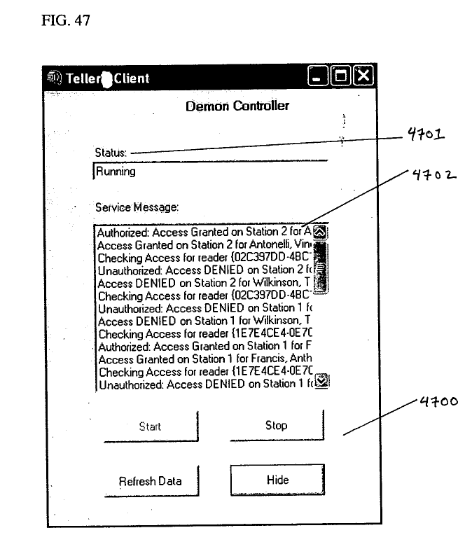

Referring to FIG. 46, there is illustrated an audit trail utility window 4600 for viewing the security transactions for any or all of the resources protected by the present invention. Audit trail utility window 4600 is useful for conducting a security audit, for assessing the efficacy of the security system and for determining whether violations of security protocol have occurred. The time, date and type of transaction 4601 are displayed in the window 4600, e.g., “attempt,” “error,” “info” and “warning.” Also included is a transaction description 4602, such as “Access granted on Station 2 for Antonelli, Vincent.” Similar information is displayed in the demon controller utility 4700 illustrated in FIG. 47. The demon controller utility 4700 provides information to the user/administrator on the status of the system, including a status window 4701 displaying whether the system is running, stopped or idle, and an event window 4702 displaying the occurrences of events within the system.

In a preferred embodiment, the present invention provides centralized control of biometric protection resources across various applications, environments and locations. Administrative server system 1000 serves as a central point for performing administrative functions such as creating new user profiles, maintaining biometric credential information and the database 1002 for storing security profile information, receiving security requests for access to resources in remote locations and for transmitting signals to those remote locations to grant access to a protected resource.

One specific embodiment of the present invention is the “Teller Client”, which contains various binary files: teller client (.exe file), teller demon (.exe file), teller library (.dll file), and address com (.dll file). The teller client file and teller demon file work together to identify tellers, verify current access for a teller station and unlock the cash drawer or compartment if access has been given.

In an embodiment, the teller demon is a non-visual Windows service which runs in the background (i.e., does not contain a Window or item in the task bar or system tray) of the Windows operating system. The teller client is a visual application which allows users to interact with teller demon. Interaction includes starting and stopping the teller demon service, refreshing the internal data of the teller demon, which includes teller information, and fingerprint device and teller station configuration data. The teller client also displays status and activity messages from teller demon. The teller client sits in the system tray of the Windows toolbar as an icon until the teller application icon is double clicked. Double clicking the teller application icon displays the visual window of teller client.

At the teller station, when a teller places their finger on a fingerprint device (configured to work with the client software), the teller demon receives the teller's fingerprint and the teller station the device is configured with. If the demon has successfully identified the teller, the demon will then determine if the teller has access to that station at the current time.

If access is granted, the demon will then unlock that station's cash drawer by sending a signal through the communication port (COM port) to an I/O relay interface board that is connected to the cash drawer. This signal will close a relay in the I/O Relay interface board. Closing the relay completes a circuit on the board that in turn energizes a solenoid. The solenoid controls the locking mechanism of the cash drawer. Energizing the solenoid unlocks the cash drawer locking mechanism.

In one embodiment, after three (3) seconds, the demon will send another signal to the I/O relay interface board to open the relay. Opening the relay will break the circuit and de-energize the solenoid. The locking mechanism of the cash drawer is now locked.

The same applies for access to the cash drawer in the vault, except the teller may gain access to the vault at any time the teller has access in the vault area and the teller has a dedicated drawer number in the vault. The dedicated number is assigned using teller application maintenance component. The demon will retrieve the dedicated vault drawer and unlock that drawer for a default time of three (3) seconds, for example.

All activity pertaining to the cash drawers (in the vault or at the teller station), such as access granted to cash drawers, denied access, unidentified fingerprint read, along with all error and warning information, such as a data base error or an improperly configured or faulty biometric device or hardware, are recorded in the database by the teller demon. Error and warning messages are also recorded in the Windows event log.

In an embodiment, the teller application utility and teller library are used to configure fingerprint devices to their applications. Preferably, the teller application uses one and only one fingerprint device and the relationship of teller's installation ID and fingerprint device ID are maintained and stored in the database.

In an embodiment, teller stations require configuring. Preferably, each teller station has one and only one fingerprint device and each teller station has one cash drawer locking mechanism connected to an I/O relay interface board. A relationship between the fingerprint device and station and the locking mechanism and the I/O relay interface are created and stored in the database with the use of the teller application utility. Also, teller stations are configured to operate with a certain teller client. More than one teller client can be operating in the system, such as on a system network; however, only one teller station can be controlled by a teller client. A relationship between the teller station and teller client is established. The teller utility also creates the building and storing of the teller client and teller station the relationships.

In an embodiment, several exemplary cases or scenarios occur in the banking environment. These include, but are not necessarily limited to, the following:

Case A. Teller starts work and requires access to cash drawer, wherein:

1. The teller client and teller demon (collectively known as teller client) are configured to control the teller's cash drawer and the biometric fingerprint device is started by the head teller.

2. The teller places her finger on the reader at her teller station.

3. The teller client software scans the fingerprint and consults the teller data store. Teller client determines that the teller is authorized to open this cash drawer at this time.

4. The teller client signals to the teller box attached to the cash drawer, which unlocks the drawer, and signals that the drawer is open with a Red lamp turned on.

5. The teller client sends another signal to lock the cash drawer after approximately three seconds. It is then left ajar, or, can be closed simply by pushing the drawer in.

Alternatively for authorization failure, at step 3, the fingerprint is read incorrectly—Allow user to rescan fingerprint; at step 3, the user is not identified in the data store—do not allow access to cash drawer and return error message.

At step 3, the user does not have access to the cash drawer at the current time—do not allow access and return error message.

Case B. Teller requires leaving station for Management Transaction Authorization, wherein:

1. A teller requires a large withdrawal (i.e., $5000) from her cash drawer. Bank policy requires that the teller must obtain authorization from the head teller for large withdrawals.

2. The teller verifies the cash drawer is open due to the red lamp being illuminated.

3. The teller pushes the drawer closed and the red lamp is not illuminated. At this point the teller can safely walk away from her station to get the needed authorization.

One alternative: at step 3, the teller does not push the drawer closed and the Red lamp is illuminated. Management is capable of noticing the drawer is open and no teller is present. (This is a very serious offense).

Case C. Head teller requires scheduling teller access to cash drawers, wherein:

1. The head teller arrives in the morning and attempts to use the teller system.

2. A dialog appears to scan his fingerprint. The teller places his finger on the reader and his print is read.

3. The teller software consults the teller data store and determines that the head teller is authorized to access the teller software and the schedule teller access function to cash drawers.

4. The head teller views his staff roster for the day using the teller's view schedule component.

5. The head teller is capable of adding teller access to certain cash drawers at times he dictates using the teller scheduler component and this information is stored in the teller data store.

Alternatively for authorization failure, at step 2, the fingerprint is read incorrectly—allow user to rescan fingerprint; at step 3, the user is not identified in the data store—do not allow access to the teller system and return error message.

At step 3, the user does not have head teller privileges to the teller system—do not allow access and return error message.

Case D. New Teller enrollment, wherein:

1. A new teller starts work at the bank.

2. A head teller logs on to the teller system using his fingerprint (see Use Case C).

3. The head teller enrolls the new teller using the add functionality of teller's maintenance component by gathering three separate copies of two fingerprints from the new teller and entering other information such as last name, first name, employee number, etc.

4. The new teller is now enrolled in the teller system and can be scheduled for cash drawer access.

Alternatively, for authorization failure, at step 2, see Case C.

Alternatively for enrollment failure, at step 3, the fingerprints are read incorrectly—allow user to rescan fingerprints.

Case E. Remove Teller, wherein:

1. A teller's employment is terminated and the teller mush be removed from the teller system.

2. A head teller logs on to the teller system using his fingerprint (see Use Case C).

3. The head teller removes the terminated teller from the system using teller's maintenance component. The teller and all corresponding scheduled cash drawer access are removed from the teller system and data store.

Alternatively for authorization failure, at step 2, see Case C.

Case F. Promotion to Head Teller, wherein:

1. A teller is promoted to head teller and requires teller application privileges.

2. A current head teller logs on to the teller system using his fingerprint (see Case C).

3. The current head teller updates the employee type of the promoted teller to head teller using the maintenance component of the teller application.

4. The new head teller now has teller application privileges and may schedule teller access to cash drawers.

See Case C for alternative.

Case G. Head Teller and Teller are required to remove a cash drawer from the vault, wherein:

1. The teller client and teller Demon (collectively know as teller client) that is configured to control the vault and biometric fingerprint device is started by the head teller.

2. The teller places her finger on the reader at the vault.

3. The teller client software scans the fingerprint and consults the teller data store. Teller client identifies the teller and determines the drawer number the teller is allowed to access

4. The teller client signals to the teller box attached to the Vault, which unlocks the teller's vault drawer.

5. The teller client sends another signal to lock to the cash drawer after approximately three seconds. It is then left ajar or can be closed simply by pushing the drawer in.

Alternatively, for authorization failure, at step 3, the fingerprint is read incorrectly—allow user to rescan fingerprint; at step 3, the user is not identified in the data store—do not allow access to vault and return error message.

Case H. Teller abandons station while their cash drawer was unlocked, wherein:

1. A teller has opened their cash drawer using their fingerprint. (See Use Case A).

2. The teller's cash drawer is unlocked by the teller client and the red lamp on the teller box is illuminated verifying the cash drawer is open.

3. The teller abandons their station.

4. A head teller notices the red lamp is illuminated and the teller is not present.

5. The head teller locks the cash drawer by pushing the cash drawer closed and the red lamp is not illuminated.

6. The head teller deals with the infraction.

Alternatively, at step 3, the teller does not push the drawer closed and the Green lamp is illuminated. Management is capable of noticing the drawer is open and no teller is present. (This is very serious offense).

Case I. Power outage, wherein:

1. The power cable attached to a Station's Teller box is accidentally disconnected and the Green lamp is not illuminated.

2. The Teller notices the Green lamp is not illuminated and immediately knows there is a power outage.

3. After investigation, the power cable is re-attached to the Station's Teller box and the Green lamp is illuminated indicating the cash drawer locking mechanism has power and is ready to operate.

Case J. Biometric device is unable to correctly scan a Teller's fingerprint, wherein:

1. During enrollment in teller application (see Case D), the system determines all the teller's fingerprints are unable to scan.

2. The teller is not able to use the fingerprint device located at the teller station. Instead, to gain access to their cash drawer, the Teller will be required to use a key and power unit to unlock the cash drawer.

3. The key and power unit is plugged into the backup switch receptacle port on the teller box and the activate button on the key and power unit is pushed.

4. The cash drawer is unlocked.

Case K. Initial installation of Teller System (i.e., no enrollments), wherein:

1. The teller management software is initially installed and the system does not contain any employee records or fingerprints.

2. A head teller starts up the teller software and logs on to teller application using a default user name and password.

3. The head teller has access to the teller software and may now change the default user name and password (for security purposes) by selecting the properties component from the file menu.

4. The head teller may now enroll himself by using the maintenance component of teller application (see Case D) and set position type to head teller (see Case F) to allow fingerprint access to the teller software.

Other Applications

As stated above, the teller system is for managing and allowing scheduled access to secure locked objects.

As will be appreciated by those having skill in the art, range of applications may be applied to any situation that requires scheduled access to a secured object in which the object is capable of being wired to a computer and wired to a mechanism to control the locking and unlocking of the secured object. The teller software is adaptable and configurable for any situation as long as the wiring is capable.

Examples of secure, locked objects are college dorm rooms, casino slot machines, hospital medicine storage cabinets, file cabinets, vaults, building elevator doors and, of course, bank teller cash drawers.

Consider a hospital environment for example. A hospital has many floors some of which only certain nurses, doctors and other personnel are allowed to be on, possibly a surgery floor. On that surgery floor, a secured room may contain cabinets of medicine or other supplies that also require security that only certain qualified and trustworthy individuals may access.

With the use of the teller system, only individuals that have scheduled access to the floors, rooms and storage cabinets will be able to gain entry to the objects at the time dictated by a privileged user (a user with administrative rights within teller system).

Some individuals may have access to some or all of the secured objects. For example, orderlies may be configured to have access to the surgery floor and secured rooms at night but have no access at all to the storage cabinets. Two nurses may be configured have access to the floor and room during the hours of their work shifts; however, one nurse is configured to only have access to cabinets containing medicine while the other nurse is configured to only have access to cabinets containing other supplies.

The teller system also allows for 24 hours a day 7 days a week access (infinity access) to any of the secured objects. For example, if a doctor is allowed access to the surgery floor and all secured rooms and locked storage cabinets at any time, that doctor may be given “infinity” access to those secured objects. The doctor will no longer have to be scheduled for access to those secured objects configured for infinity access giving that doctor access to those secured objects at any time. However, if there are other secured objects that were not configured to give infinity access to the doctor, those objects will have to be scheduled in order for the doctor to gain access. For example, the doctor has infinity access to the surgery floor, the secured room and the storage cabinets but not the records room. Since the doctor was not configured to have infinity access to the records room, the doctor will have to be explicitly scheduled to gain access to the records room.

The teller system is flexible to allow the capability of creating many combinations of scheduled access. The combinations are made up of individuals and secured objects; the large number of combinations are created by configuring an individual to be scheduled for more than one object (i.e., many floors, many storage cabinets) at a given time and many individuals to be scheduled for access to the same secured object at the same time.

To use the system, individuals must first be enrolled within the teller system application. To enroll within the teller system, a privileged user (a user with administrative rights with the teller system) logs in to teller application using their fingerprint and gathers information from the user along with fingerprint samples. The fingerprint samples are obtained using a biometric fingerprint scanner that communicates with the teller software. After passing data and fingerprint validation checks, the individual information is stored in the teller database and the individual may now be scheduled for access.

To schedule the access to a particular object, a privileged user uses teller application to schedule the individual for that object on a day and time period the privileged user dictates.

After the individual is scheduled, they may gain access to that secured object by placing their finger on the biometric fingerprint device associated with the object. Teller client software scans the fingerprint and will attempt to identify the individual. If identified, teller client will determine which secured object is attempting to be accessed. Teller client then uses these two pieces of information (the individual and the secured object) along with current time to determine if the individual has access to the object at this moment in time. If access is granted, the teller client will then unlock the secured object and then lock the object after the predetermined unlock time has expired.

As indicated above, the present invention can be implemented in an enterprise-wide system, using plug-in applications, such as for example the teller application. The central portion or application of the system can be utilized for administration of the users user information, related biometric information, schedules, etc., as specified above, for all applications within the enterprise. For example, a banking enterprise may have a need for the teller system application, a general access security system application for doors, and a automated entry system application for automated entry into a safety deposit box area, each of which plugs into the central application for common use of the functionality of the central application, as specified above. The present invention can also be implemented with the central portion application integrated with a particular functional application, such as the teller application, in a non plug-in arrangement.

Furthermore, the central application can be used across multiple locations, such as branches of a bank or banking system utilizing the teller application, so that the administration can be performed from a centralized location or user interface, with a limited set of managers having access to such administration. In the teller application, employees will be able to work at multiple braches of a bank without mangers having to enter/administer information for such employees multiple times. A “master” schedule can be implemented through the central application that is applicable among multiple or all branches within the banking enterprise. This implementation can be used in other applications as well, separately or simultaneously.

It should be emphasized that the above-described embodiments of the present invention are examples of implementations, and are merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and by the following claims.

What is claimed is:

1. An administration system for maintaining identification information and facilitating user identification by client applications comprising:
a server configured to communicate with a plurality of client applications;
a central access administration application running on the server wherein the central access administration application is configured to interact with the plurality of client applications,
the central access administration application configured to receive user credential information from one of the plurality of client applications of a user of the one client application, the received user credential information including biometric identity data and non-biometric credential data of the user,
a database communicatively coupled to the central access administration application, the database storing user credential information of a plurality of enrolled users of the system, wherein the central access administration application is configured to retrieve enrolled user credential information stored in the database and compare the retrieved enrolled user credential information with the received user credential information from the one client application to verify the purported identity of the user of the one client application.

2. The administration system of claim 1 wherein the central access administration application is configured to receive profiles of new users for storing in the database.

3. The administrative system of claim 1 further comprising a biometric input device for providing the biometric identity data of the user of the one client application.

4. The administration system of claim 3 wherein the biometric input device is a fingerprint scanner.

5. The administration system of claim 1 wherein the server is communicatively coupled to a network.

6. The administration system of claim 1 wherein the server is coupled to a plurality of network ports.

7. The administration system of claim 6 wherein the central access administration application is configured to operate in a listening mode by scanning the plurality of network ports.

8. An administration method for maintaining identification information and facilitating user identification by client applications, the method comprising the steps of:
providing a server running a central access administration application;
retrieving user credential information of a plurality of enrolled users by the central access administration application, the user credential information including biometric identity data of each the plurality of enrolled users;
storing the user credential information of the plurality of enrolled users in a database coupled to the server;
receiving from a client application user credential information of a user of the client application by the central access administration application; and,
comparing the user credential information of the user of the client application with the user credential information of the plurality of enrolled user stored in the database by the central access administration application.

9. The method of claim 8 further comprising the step of:
transmitting a signal to the client application indicating whether the user credential information of the user of the client application matches any user credential information of the plurality of enrolled user stored in the database by the central access administration application.

10. The method of claim 8 further comprising the step of:
scanning a plurality of network ports for receipt of a communication from a client application by the central access administration application.

11. The method of claim 8 further comprising the steps of:
creating a new user profile for a new user, the new user profile including credential information having biometric identity data; and,
storing the new user profile in the database.

12. The method of claim 8 wherein the user credential information includes non-biometric credential information.

13. The method of claim 8 further comprising the steps of:
scanning a fingerprint of the user of the client application; and,
transmitting the scanned fingerprint to the central access administration application by the client application.

14. The method of claim 8 further comprising the steps of:
retrieving access schedule information for the user of the client application from the database; and,
transmitting the access schedule information for the user to the client application by the central access administration application.

15. The method of claim 8 wherein the user credential information includes the purported identity of the user of the client application.

16. A central administration method for maintaining user credential information of a plurality of users and facilitating identification of such users by various applications, the method comprising the steps of:
retrieving user credential information of a plurality of users, the user credential information of each of the plurality of users including biometric identity data and non-biometric credential data;
storing the user credential information of the plurality of users in a database;
receiving a communication from a client application, the communication including user credential information of a user of the client application;
comparing the user credential information of the user of the client application with the user credential information of the plurality of users stored in the database; and,
transmitting a signal indicative of whether the user credential information of the user of the client application matches any user credential information of the plurality of users stored in the database.

17. The method of claim 16 further comprising the steps of:
retrieving pre-existing user credential information of a plurality of pre-existing users, the pre-existing user credential information including non-biometric credential information without corresponding biometric identity data; and,
updating the pre-existing user credential information to include biometric identity data for each of the plurality of pre-existing users.

18. The method of claim 16 further comprising the step of:
storing security profile information for each of the plurality of users in the database; and,
transmitting to the client application the security profile information of the user of the client application upon determination of a match of the user credential information of the user of the client application with any user credential information of the plurality of users stored in the database.

19. The method of claim 16 further comprising the steps of:
providing a server running a central access administration application; and,
coupling the server to a network.

20. The method of claim 16 further comprising the step of:
scanning a fingerprint of the user of the client application to obtain the biometric identity data.
